(19) United States
(12) Patent Application Publication
(10) Pub. No.: US 2010/0281121 A1
(43) Pub. Date: Nov. 4, 2010

(54) DYNAMIC DIGITIZED VISUAL ICON AND METHODS FOR GENERATING THE AFOREMENTIONED

(75) Inventors: Kok Hoong Vincent Cheng, Singapore (SG); Teck Chee Lee, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 12/747,496

(22) PCT Filed: Dec. 11, 2008
(86) PCT No.: PCT/SG08/00474

§ 371 Date: Jun. 10, 2010

(30) Foreign Application Priority Data
Dec. 11, 2007 (SG) 200718539-0

(51) Int. Cl. G06F 15/16

(52) U.S. Cl. 709/206

(57) ABSTRACT

There is provided a dynamic digitized visual icon appearing on a sender's and recipient's display with the icon being used to represent at least one word in a language that is being used by the sender during text messaging. The icon may include a static base image; and at least one component image overlaid onto the base image. The at least one component image may vary in accordance with determining an aspect selected from the group consisting of, for example, the at least one word, a preferred characteristics of the sender/recipient or a combination of both the aforementioned aspects. It is advantageous that the icon alters appearance whenever the at least one word is used by the sender/received by the recipient during text messaging. Corresponding methods to generate the aforementioned icons are also disclosed.

### FIELD OF INVENTION

The present invention relates to a digitized visual icon which changes in accordance with a particular set of parameters and a method detailing how the digitized visual icon changes in accordance with a particular set of parameters.

### BACKGROUND

Text-based communications have been prevalent through time. However, letters in paper form (hardcopy) are becoming less commonly used by the generation of children being educated today. This generation is most familiar with text-based communications in the form of emails, short message service (SMS) and instant messaging such as, for example, MSN Messenger, Yahoo Messenger, ICQ. Words have always been used for communication, but it is undeniable that the phrase “A picture speaks a thousand words” holds true.

In this regard, it is apparent that appropriate visual icons used in combination with text during text-based communication would enhance a communication experience between communicating parties.

Currently, there are mechanisms in place allowing senders to incorporate visual icons into both SMS-es and instant messages for a myriad of reasons such as, for example, to emphasize a message, for the sake of fun, for the sake of vanity and so forth. However, the visual icons are selected based solely on choices made by the sender. The recipient of the visual icons have no control over what they receive and as such, the recipient may not be interested by the content transmitted by the sender and the recipient may correspondingly not be bothered to carry out communications with the sender.

The present invention aims to address this problem.

### SUMMARY

In a first aspect, there is provided a dynamic digitized visual icon appearing on a senders display with the icon being used to represent at least one word in a language that is being used by the sender during text messaging. The icon may include a static base image; and at least one component image overlaid onto the base image. The at least one component image may vary in accordance with determining an aspect selected from the group consisting of, for example, the at least one word, a preferred characteristics of the sender or a combination of both the aforementioned aspects. It is advantageous that the icon alters appearance whenever the at least one word is used by the sender during text messaging.

Preferably, the at least one component image is animated. The preferred characteristics may be selected from, for example, the sender's hobby, the sender's likes, the senders mood, the sender's character, or any combination of the aforementioned. The static base image may be either a graphic representation or a photographic representation. Similarly, the at least one component image may be either a graphic representation or a photographic representation. Preferably, the at least one word is determined using a vocabulary listing stored in the senders apparatus. It is preferable that the icon is selected from, for example, theme-based, sender definable, allocated by the apparatus, or any combination of the aforementioned. The icon appearing on the sender's display may be transmitted to a recipient for viewing by the recipient.

In another aspect, there is provided a dynamic digitized visual icon appearing on a recipient's display with the icon being used to represent at least one word in a language and the at least one word being received by the recipient during text messaging. The icon includes a static base image; and at least one component image overlaid onto the base image. The at least one component image may vary in accordance with determining an aspect such as, for example, the at least one word, a preferred characteristics of the recipient or a combination of both the aforementioned aspects. It is advantageous that the icon alters appearance whenever the at least one word is received by the recipient during text messaging.

Preferably, the at least one component image is animated. The preferred characteristics may be selected from, for example, the recipient's hobby, the recipient's likes, the recipient's mood, the recipient's character, or any combination of the aforementioned. The static base image may be either a graphic representation or a photographic representation. Similarly, the at least one component image may be either a graphic representation or a photographic representation. Preferably, the at least one word is determined using a vocabulary listing stored in the sender's apparatus. It is preferable that the icon is selected from, for example, theme-based, recipient definable, allocated by the apparatus, or any combination of the aforementioned. The icon appearing on the recipient's display may be transmitted to a sender for viewing by the sender.

There is also provided a method of generating a dynamic digitized visual icon appearing on a sender's display with the icon being used to represent at least one word in a language with the at least one word being used by the sender during text messaging. The method includes determining an aspect such as, for example, the at least one word, a preferred characteristics of the sender or a combination of both the aforementioned aspects; and overlaying at least one component image onto a static base image. It is advantageous that the icon alters appearance whenever the at least one word is used by the sender during text messaging.

Preferably, the at least one component image is animated. The preferred characteristics may be selected from, for example, the sender's hobby, the sender's likes, the sender's mood, the sender's character, or any combination of the aforementioned. The static base image may be either a graphic representation or a photographic representation. Similarly, the at least one component image may be either a graphic representation or a photographic representation. Preferably, the at least one word is determined using a vocabulary listing stored in the sender's apparatus. It is preferable that the icon is selected from, for example, theme-based, sender definable, allocated by the apparatus, or any combination of the aforementioned. The method may further include transmitting the icon to a recipient for viewing by the recipient.

In a final aspect, there is provided a method of generating a dynamic digitized visual icon appearing on a recipient's display with the icon being used to represent at least one word in a language and the at least one word being received by the recipient during text messaging. The method may include determining an aspect such as, for example, the at least one word, a preferred characteristics of the recipient and a combination of both the aforementioned aspects; and overlaying at least one component image onto a static base image. Advantageously, the icon alters appearance whenever the at least one word is received by the recipient during text messaging.

Preferably, the at least one component image is animated. The preferred characteristics may be selected from, for example, the recipient's hobby, the recipient's likes, the recipient's mood, the recipient's character, or any combination of the aforementioned. The static base image may be either a graphic representation or a photographic representation. Similarly, the at least one component image may be either a graphic representation or a photographic representation. Preferably, the at least one word is determined using a vocabulary listing stored in the sender's apparatus. It is preferable that the icon is selected from, for example, theme-based, recipient definable, allocated by the apparatus, or any combination of the aforementioned. The method may further include transmitting the icon to a sending for viewing by the sender.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows an example of a visual icon of the present invention.

FIGS. 2(a)-2(f) show examples of constituents of the visual icon of the present invention.

FIG. 3 shows an example of the present invention when in use.

FIG. 4 shows a process flow of a method of the present invention (sender end).

FIG. 5 shows a process flow of the method of the present invention (recipient end).

### DESCRIPTION OF PREFERRED EMBODIMENTS

Referring to FIG. 1, there is shown a non-limiting representation of a dynamic digitized visual icon 20 appearing on either a sender's or a recipient's display. The sender's and recipient's display may be part of an apparatus such as, for example, a personal computer, a wireless handheld device, a mobile phone and so forth. The appearance of the icon 20 on either the sender's or the recipient's display need not be identical. Similarly, the appearance of the icon 20 on either the sender's or the recipient's display need not be related to each other. While the icon 20 is shown in FIG. 1 and other parts of this specification to be in the form of a humanoid representation, it is not mandatory for the icon 20 to be represented in such a manner. The body 18 and the background 16 of the icon 20 may be varied although this is not described in the present specification.

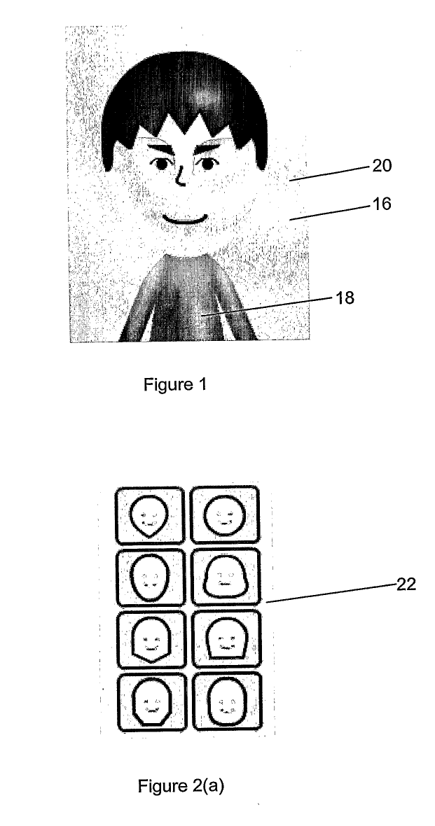

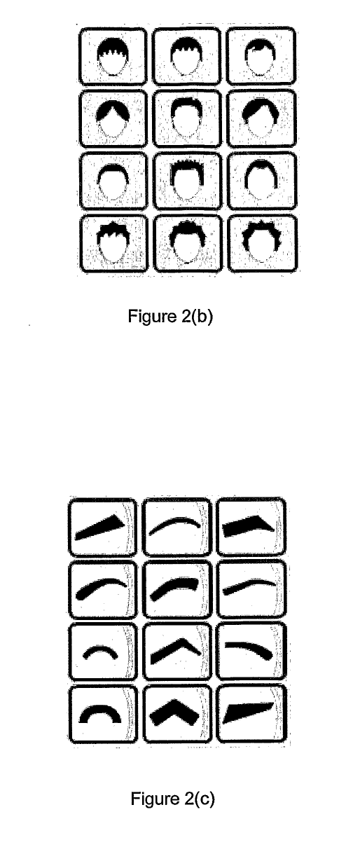

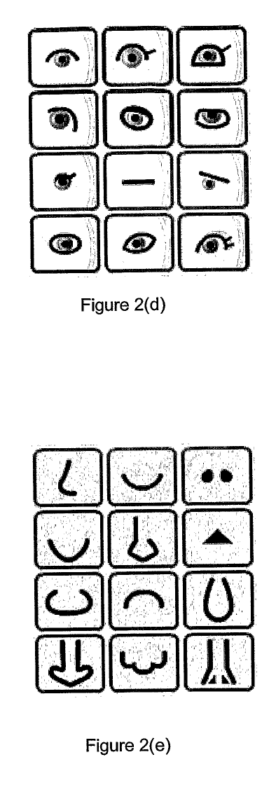

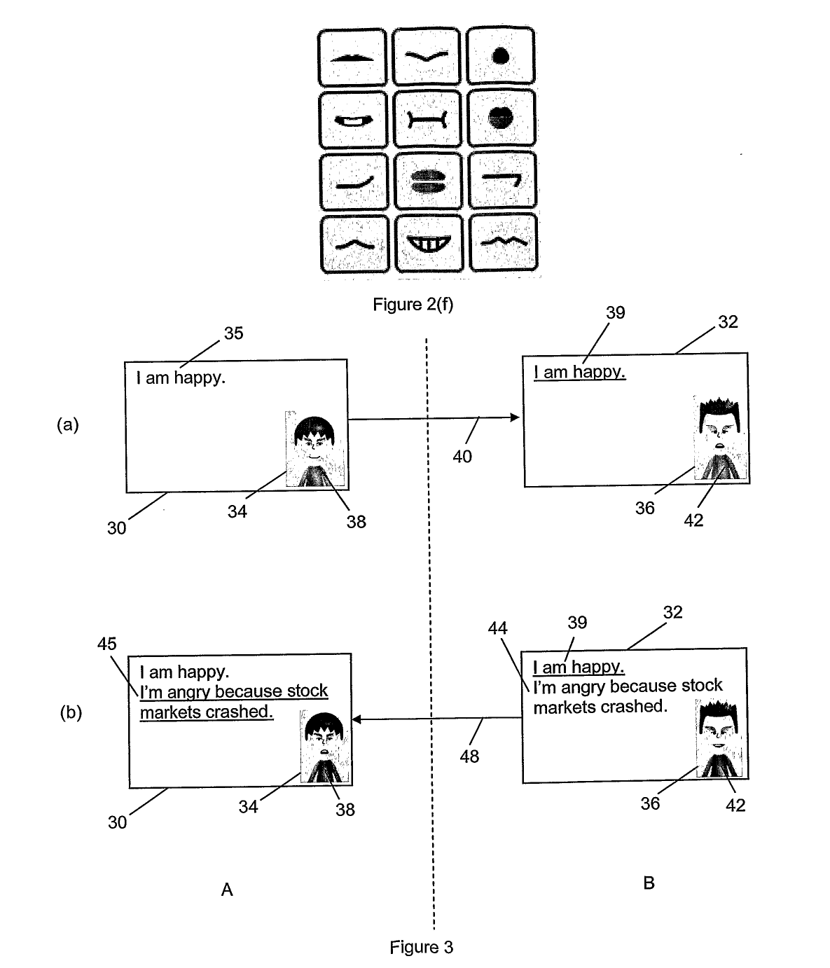

The icon 20 may be used to represent at least one word in a language. In a first aspect, the at least one word may be used by the sender during text messaging. The at least one word may be determined using a vocabulary listing stored in the sender's apparatus. The vocabulary listing in the sender's apparatus may differ from the vocabulary listing in the recipient's apparatus. The vocabulary listing may be in the form of a look-up table. FIG. 2 shows examples of constituents of the icon 20. The icon 20 includes a static base image. Referring to FIG. 2(a), the static base image is one of a selection 22 of facial shapes of the humanoid representation and typically acts as a background for the icon 20 and does not substantially change when an appearance of the icon 20 changes. The static base image may be either a graphic representation or a photographic representation. It should be noted that the dynamic nature of the icon 20 results from changes in the appearance of the icon 20 when the sender uses different words during text messaging.

In addition, the icon 20 also includes at least one component image (shown in FIGS. 2(b)-2(f)) which may be overlaid onto the base image to vary the appearance of the icon 20. Referring to FIGS. 2(b)-2(f), examples of component images are depicted in the following figures:

FIG. 2(b)—hair style;
FIG. 2(c)—eye brow shape;
FIG. 2(d)—eyes structure;
FIG. 2(e)—nose structure; and
FIG. 2(f)—mouth structure.

The at least one component image (shown in FIGS. 2(b)-2(f)) may be animated. The at least one component image (shown in FIGS. 2(b)-2(e)) may be either a graphic representation or a photographic representation. The at least one component image (shown in FIGS. 2(b)-2(f)) may vary in accordance with determination of an aspect like the at least one word, a preferred characteristics of the sender and a combination of both the aforementioned aspects. The preferred characteristics may be selected from, for example, the sender's hobby, the sender's likes, the sender's mood, the sender's character, and any combination of the aforementioned. The combination of the aforementioned may be in the form of weightage. For example, the sender's mood/hobby/character may take up 80%/10%/10% respectively of the preferred characteristics. The preferred characteristics and/or weightage may be entered into the sender's apparatus when the sender so desires. The icon 20 may alter its appearance whenever the at least one word is used by the sender during text messaging. The icon 20 may be, for example, theme-based, sender definable, allocated by the apparatus, or any combination of the aforementioned. There may be a default setting of the preferred characteristics if the sender does not specify any preferred characteristics. The icon 20 seen on the sender's display may also be transmitted to the recipient for viewing by the recipient.

In a second aspect, the at least one word may be received by the recipient during text messaging. The at least one word may be determined using a vocabulary listing stored in the recipient's apparatus. The vocabulary listing in the recipient's apparatus may differ from the vocabulary listing in the sender's apparatus. The vocabulary listing may be in the form of a look-up table. FIG. 2 shows examples of constituents of the icon 20. The icon 20 includes a static base image. Referring to FIG. 2(a), the static base image is one of a selection 22 of facial shapes of the humanoid representation and typically acts as a background for the icon 20 and does not substantially change when an appearance of the icon 20 changes. The static base image may be either a graphic representation or a photographic representation. It should be noted that the dynamic nature of the icon 20 results from changes in the appearance of the icon 20 when the recipient receives different words during text messaging.

In addition, the icon 20 also includes at least one component image (shown in FIGS. 2(b)-2(f)) which may be overlaid onto the base image 22 to vary the appearance of the icon 20. Referring to FIGS. 2(b)-2(f), examples of component images are depicted in the following figures:

FIG. 2(b)—hair style;
FIG. 2(c)—eye brow shape;
FIG. 2(d)—eyes structure;
FIG. 2(e)—nose structure; and
FIG. 2(f)—mouth structure.

The at least one component image (shown in FIGS. 2(b)-2(f)) may be animated. The at least one component image (shown in FIGS. 2(b)-2(f)) may be either a graphic representation or a photographic representation. The at least one component image (shown in FIGS. 2(b)-2(f)) may vary in accordance with determination of an aspect like the at least one word, a preferred characteristics of the recipient and a combination of both the aforementioned aspects. The preferred characteristics may be selected from, for example, the recipient's hobby, the recipient's likes, the recipient's mood, the recipient's character, and any combination of the aforementioned. The combination of the aforementioned may be in the form of weightage. For example, the recipient's mood/hobby/character may take up 80%/10%/10% respectively of the preferred characteristics. The preferred characteristics and/or weightage may be entered into the recipient's apparatus when the recipient so desires. The icon 20 may alter its appearance whenever the at least one word is received by the recipient during text messaging. The icon 20 may be, for example, theme-based, recipient definable, allocated by the apparatus, or any combination of the aforementioned. There may be a default setting of the preferred characteristics if the recipient does not specify any preferred characteristics. The icon 20 seen on the recipient's display may also be transmitted to the sender for viewing by the sender.

FIG. 3 provides an illustration of the first two aspects as mentioned above. FIG. 3 illustrates text based communication between parties A and B. For the sake of illustration, B has had a bad day and B has input into an apparatus that B is in a foul mood. In a similar vein, A has had an ordinary day and has sought to communicate with B. FIG. 3(a) shows the initial contact of A to B, while FIG. 3(b) shows the response of B to A. Displays 30 in column A show screens on A's apparatus, while displays 32 in column B show screens on B's apparatus. In this simplified illustration, it should be noted that messages which are underlined are received messages.

When A composes a message of “I am happy” 35 for B, a first sub-window 34 in the display 30 shows a first icon 38. The first icon 38 is denoted as a smiling facial representation in response to the word “happy” and A's preferred characteristics. The meaning of the word “happy” is found in a vocabulary listing on A's apparatus. A has input into A's apparatus characteristics like, for example, A's hobby, A's likes, A's mood, A's character, and so forth. The representation of the first icon 38 may be assigned by A's apparatus or may be pre-defined by A. The representation may be in the form of a particular theme. The icon 38 remains in the same representation subsequent to the message being sent 40 from A to B.

When B receives a message of “I am happy” 39 from A, a second sub-window 36 shows a second icon 42. The second icon 42 is denoted by a scowling facial expression in response to the word “happy” and B's preferred characteristics. The meaning of the word “happy” is found in a vocabulary listing on B's apparatus. B has input into B's apparatus characteristics like, for example, B's hobby, B's likes, B's mood, B's character, and so forth. The representation of the second icon 42 may be assigned by B's apparatus or may be pre-defined by B. The representation may be in the form of a particular theme. In this instance, B is in a foul mood and the icon 42 is has an expression of dismay as it represents how B feels aggrieved that someone else is happy when he is unhappy.

Subsequently, B composes a message “I′m angry because stock markets crashed” 44 in response to A's message of “I am happy” 39. The second icon 42 in the second sub-window 36 shows a smiling facial representation in response to the word “angry” and B's preferred characteristics. B is someone who appreciates that anger helps in focusing on a matter, and thus, a resultant meaning of the word “angry” is found in a vocabulary listing on B's apparatus.

When A receives a message of “I′m angry because the stock markets crashed” 45 transmitted 48 from B, the first icon 38 in the first sub-window 34 shows a worried facial representation in response to the word “angry” and A's preferred characteristics. A is someone who appreciates that anger is undesirable, and thus, a resultant meaning of the word “angry” is found in a vocabulary listing on A's apparatus.

Thus it can be seen that the icons 38/42 appearing in the sub-windows 34/36 differ based on the individuality of the owners (A and B) of the apparatus. It should be noted that the feature of the recipient being able to view the icon generated on the sender's display and the sender being able to view the icon generated on the recipient's display is not denoted in FIG. 3 as it is an optional feature.

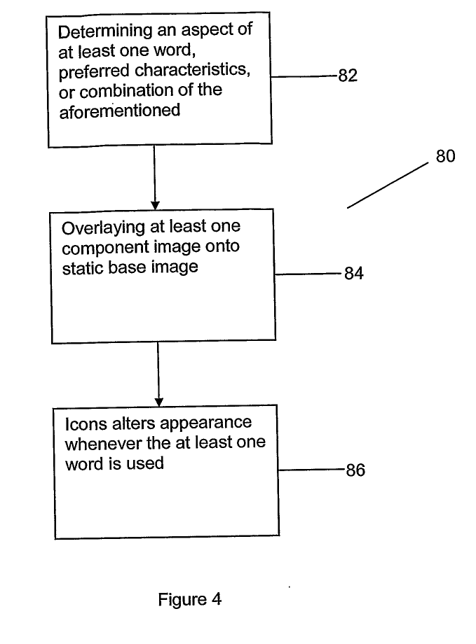

In a third aspect as shown in FIG. 4, there is provided a method 80 of generating a dynamic digitized visual icon appearing on a sender's display. The sender's display may be part of an apparatus such as, for example, a personal computer, a wireless handheld device, a mobile phone and so forth. The icon may be used to represent at least one word in a language with the at least one word being used by the sender during text messaging. The at least one word may determined using a vocabulary listing stored in the sender's apparatus. The vocabulary listing may be in the form of a look-up table.

The method 80 includes determining an aspect selected from the group consisting of: the at least one word, a preferred characteristics of the sender and a combination of both the aforementioned aspects (82). Subsequently, at least one component image is overlaid onto a static base image (84). The at least one component image may be animated. The preferred characteristics may be, for example, the sender's hobby, the sender's likes, the sender's mood, the sender's character, or any combination of the aforementioned. The combination of the aforementioned may be in the form of weightage. For example, the sender's mood/hobby/character may take up 80%/10%/10% respectively of the preferred characteristics. The preferred characteristics and/or weightage may be entered into the sender's apparatus when the sender so desires.

The static base image typically acts as a background for the icon and does not substantially change when an appearance of the icon changes. The static base image may be either a graphic representation or a photographic representation. Similarly, the at least one component image is either a graphic representation or a photographic representation.

In this regard, the icon alters appearance whenever the at least one word is used (86) during text messaging. It should be noted that the icon may be selected in terms of theme-based, sender definable, allocated by the apparatus, or any combination of the aforementioned. The appearance of the icon on either the sender's or the recipient's display need not be identical. Similarly, the appearance of the icon on either the sender's or the recipient's display need not be related to each other. The method 80 may further include transmitting the icon on the sender's display to a recipient for viewing by the recipient.

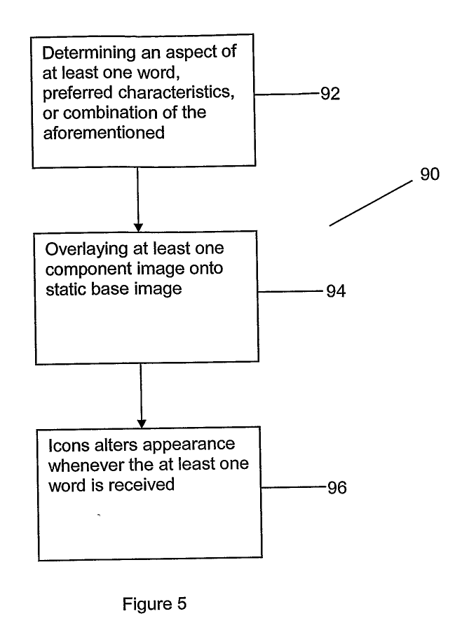

In a final aspect as shown in FIG. 5, there is provided a method 90 of generating a dynamic digitized visual icon appearing on a recipient's display. The recipient's display may be part of an apparatus such as, for example, a personal computer, a wireless handheld device, a mobile phone and so forth. The icon may be used to represent at least one word in a language with the at least one word being received by the recipient during text messaging. The at least one word may determined using a vocabulary listing stored in the recipient's apparatus. The vocabulary listing may be in the form of a look-up table.

The method 90 includes determining an aspect selected from the group consisting of: the at least one word, a preferred characteristics of the sender and a combination of both the aforementioned aspects (92). Subsequently, at least one component image is overlaid onto a static base image (94). The at least one component image may be animated. The preferred characteristics may be, for example, the recipient's hobby, the recipient's likes, the recipient's mood, the recipient's character, or any combination of the aforementioned. The combination of the aforementioned may be in the form of weightage. For example, the recipient's mood/hobby/character may take up 80%/10%/10% respectively of the preferred characteristics. The preferred characteristics and/or weightage may be entered into the recipient's apparatus when the recipient so desires.

The static base image typically acts as a background for the icon and does not substantially change when an appearance of the icon changes. The static base image may be either a graphic representation or a photographic representation. Similarly, the at least one component image is either a graphic representation or a photographic representation.

In this regard, the icon alters appearance whenever the at least one word is received (96) during text messaging. It should be noted that the icon may be selected in terms of theme-based, sender definable, allocated by the apparatus, or any combination of the aforementioned. The appearance of the icon on either the sender's or the recipient's display need not be identical. Similarly, the appearance of the icon on either the sender's or the recipient's display need not be related to each other. The method 90 may further include transmitting the icon on the recipient's display to a sender for viewing by the sender.

Whilst there has been described in the foregoing description preferred embodiments of the present invention, it will be understood by those skilled in the technology concerned that many variations or modifications in details of design or construction may be made without departing from the present invention.

1. A dynamic digitized visual icon appearing on a sender's display, the icon being used to represent at least one word in a language, the at least one word being used by the sender during text messaging, the icon including:
a static base image; and
at least one component image overlaid onto the base image, the at least one component image varying in accordance with determining an aspect selected from the group consisting of: the at least one word, a preferred characteristics of the sender and a combination of both the aforementioned aspects;
wherein the icon alters appearance whenever the at least one word is used by the sender during text messaging.

2. The icon of claim 1, wherein the at least one component image is animated.

3. The icon of claim 1, wherein the preferred characteristics is selected from the group consisting of: the sender's hobby, the sender's likes, the sender's mood, the sender's character, and any combination of the aforementioned.

4. The icon of claim 1, wherein the static base image is either a graphic representation or a photographic representation.

5. The icon of claim 1, wherein the at least one component image is either a graphic representation or a photographic representation.

6. The icon of claim 1, wherein the at least one word is determined using a vocabulary listing stored in the sender's apparatus.

7. The icon of claim 1, wherein the icon is selected from the group consisting of: theme-based, sender definable, allocated by the apparatus, and any combination of the aforementioned.

8. The icon of claim 1, wherein the icon appearing on the sender's display is transmitted to a recipient for viewing by the recipient.

9. A dynamic digitized visual icon appearing on a recipient's display, the icon being used to represent at least one word in a language, the at least one word being received by the recipient during text messaging, the icon including:
a static base image; and
at least one component image overlaid onto the base image, the at least one component image varying in accordance with determining an aspect selected from the group consisting of: the at least one word, a preferred characteristics of the recipient and a combination of both the aforementioned aspects;
wherein the icon alters appearance whenever the at least one word is received by the recipient during text messaging.

10. The icon of claim 9, wherein the at least one component image is animated.

11. The icon of claim 9, wherein the preferred characteristics is selected from the group consisting of: the recipient's hobby, the recipient's likes, the recipient's mood, the recipient's character, and any combination of the aforementioned.

12. The icon of claim 9, wherein the static base image is either a graphic representation or a photographic representation.

13. The icon of claim 9, wherein the at least one component image is either a graphic representation or a photographic representation.

14. The icon of claim 9, wherein the at least one word is determined using a vocabulary listing stored in the recipient's apparatus.

15. The icon of claim 9, wherein the icon is selected from the group consisting of: theme-based, recipient definable, allocated by the apparatus, and any combination of the aforementioned.

16. The icon of claim 9, wherein the icon appearing on the recipient's display is transmitted to a sender for viewing by the sender.

17. A method of generating a dynamic digitized visual icon appearing on a sender's display, the icon being used to represent at least one word in a language, the at least one word being used by the sender during text messaging, the method including:
determining an aspect selected from the group consisting of: the at least one word, a preferred characteristics of the sender and a combination of both the aforementioned aspects; and
overlaying at least one component image onto a static base image,
wherein the icon alters appearance whenever the at least one word is used by the sender during text messaging.

18. The method of claim 17, wherein the at least one component image is animated.

19. The method of claim 17, wherein the preferred characteristics is selected from the group consisting of: the sender's hobby, the sender's likes, the sender's mood, the sender's character, and any combination of the aforementioned.

20. The method of claim 17, wherein the static base image is either a graphic representation or a photographic representation.

21. The method of claim 17, wherein the at least one component image is either a graphic representation or a photographic representation.

22. The method of claim 17, wherein the at least one word is determined using a vocabulary listing stored in the sender's apparatus.

23. The method of claim 17, wherein the icon is selected from the group consisting of: theme-based, sender definable, allocated by the apparatus, and any combination of the aforementioned.

24. The method of claim 17, further including transmitting the icon on the sender's display to a recipient for viewing by the recipient.

25. A method of generating a dynamic digitized visual icon appearing on a recipient's display, the icon being used to represent at least one word in a language, the at least one word being received by the recipient during text messaging, the method including:
determining an aspect selected from the group consisting of: the at least one word, a preferred characteristics of the recipient and a combination of both the aforementioned aspects; and
overlaying at least one component image onto a static base image,
wherein the icon alters appearance whenever the at least one word is received by the recipient during text messaging.

26. The method of claim 25, wherein the at least one component image is animated.

27. The method of claim 25, wherein the preferred characteristics is selected from the group consisting of: the recipient's hobby, the recipient's likes, the recipient's mood, the recipient's character, allocated by the apparatus, and any combination of the aforementioned.

28. The method of claim 25, wherein the static base image is either a graphic representation or a photographic representation.

29. The method of claim 25, wherein the at least one component image is either a graphic representation or a photographic representation.

30. The method of claim 25, wherein the at least one word is determined using a vocabulary listing stored in the recipient's apparatus.

31. The method of claim 25, wherein the icon is selected from the group consisting of: theme-based, recipient definable, allocated by the apparatus, and any combination of the aforementioned.

32. The method of claim 25, further including transmitting the icon on the recipient's display to a sender for viewing by the sender.
